(19) United States
(12) Patent Application Publication
(10) Pub. No.: US 2007/0237358 A1
(43) Pub. Date: Oct. 11, 2007

(54) Surveillance system with dynamic recording resolution and object tracking

(76) Inventors: Wei-Nan William Tseng, Taipei City (TW); Chih-Yang Wang, Taipei Hsien (TW); Hung-Yi Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/279,394

(22) Filed: Apr. 11, 2006

(51) Int. Cl. G06K 9/00; H04N 7/18

(52) U.S. Cl. 382/103; 382/118; 348/152

(57) ABSTRACT

A surveillance system includes a plurality of microphones for generating audio signals in response to detecting sound, a video camera for generating a stream of video signals, and a driving unit for controlling the direction in which the video camera points. The surveillance system also includes a decision unit for determining a location from which the detected sound is coming from based on the differences in the audio signals generated by the plurality of microphones to control the driving unit to point the video camera in the direction of the location from which the detected sound is coming from.

### BACKGROUND OF THE INVENTION

1. Field of the Invention

The present invention relates to a surveillance system, and more specifically, to a surveillance system capable of tracking objects and dynamically changing the resolution of stored video.

2. Description of the Prior Art

Conventionally, surveillance systems used for home security usually capture images in a fixed region. The surveillance systems cannot quickly respond when someone enters the house. Moreover, fixed recording resolution is used in traditional surveillance systems. This leaves users with a tradeoff involving the choice between longer recording time or higher resolution recordings. Capturing images with high resolution is necessary when an intruder enters the house. However, more storage space is needed to store high resolution images. Furthermore, in normal situations when there is no intruder present, it is not efficient to capture images with higher resolution.

### SUMMARY OF THE INVENTION

It is therefore an objective of the claimed invention to provide a home surveillance system and related surveillance method in order to solve the above-mentioned problems.

According to an embodiment of the claimed invention, a surveillance system includes a plurality of microphones for generating audio signals in response to detecting sound, a video camera for generating a stream of video signals, and a driving unit for controlling the direction in which the video camera points. The surveillance system further comprises a decision unit for determining a location from which the detected sound is coming from based on the differences in the audio signals generated by the plurality of microphones to control the driving unit to point the video camera in the direction of the location from which the detected sound is coming from.

According to another embodiment of the present invention, a method of performing video and audio surveillance includes generating audio signals with a plurality of microphones, generating a stream of video signals with a video camera, determining a location from which the detected sound is coming from based on the differences in the audio signals generated by the plurality of microphones, and driving the video camera to point in the direction of the location from which the detected sound is coming from.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance system according to the present invention.

FIG. 2 is a flowchart illustrating the present invention surveillance method.

### DETAILED DESCRIPTION

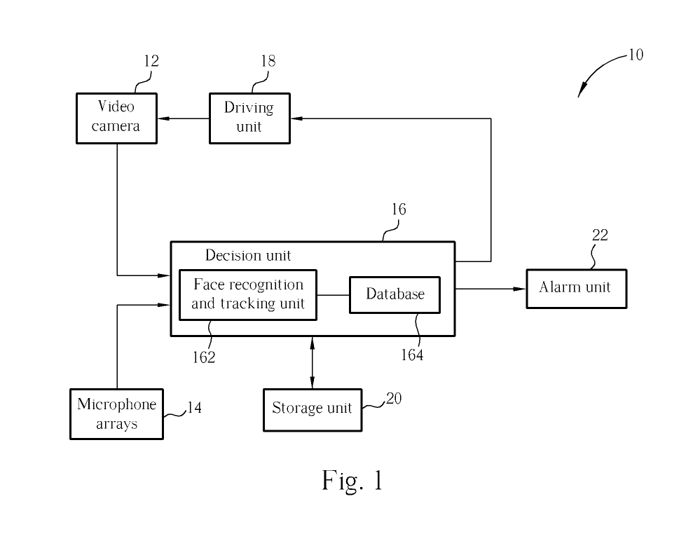

Please refer to FIG. 1. FIG. 1 is a functional block diagram of a surveillance system 10 according to the present invention. The surveillance system 10 can be used for home security or in other environments such as in an office setting. The surveillance system 10 receives input from a video camera 12 and microphone arrays 14. The microphone arrays 14 contain multiple microphones placed at different locations. Using sound propagation principles, the individual microphone signals can be filtered and combined to enhance sound originating from a particular direction or location. The location of the principal sounds sources can also be determined dynamically by investigating the correlation between different microphone channels.

Audio signals received from the microphone arrays 14 and a stream of video signals generated by the video camera 12 are sent to a decision unit 16. The decision unit 16 uses the sound information provided by the microphone arrays 14 to determine the location that the sound is coming from, and instructs a driving unit 18 to point the video camera 12 to point in the direction of the sound.

The decision unit 16 contains a database 164 containing facial images corresponding to a list of approved users, such as the residents of the house that the surveillance system 10 is installed in. The database 164 works in conjunction with a face recognition and tracking unit 162 in order to determine the presence and the location of a face in an image by distinguishing the face from all other patterns in the scene. Most approaches exploit the temporal correlation between successive frames in order to refine the localization of the target. The purpose of face tracking is used to follow one or more faces through a video sequence. Face recognition also allows the tracked face to be compared with the faces that have been registered in the database 164 to ensure that people entering the area under surveillance are approved users.

A storage unit 20 is used to record the audio signals generated by the microphone arrays 14 and the stream of video signals generated by the video camera 12. The recording quality is an important factor for face recognition. Images with higher quality allow for higher recognition accuracy. For example, it is beneficial to increase the recording resolution or color quality when the surveillance system 10 is in an emergency state or when an intruder is detected. However, recording at higher resolution or at higher color quality increases the amount of storage space that is needed. Therefore, in one embodiment of the invention, we can apply a lower resolution or lower color quality when the surveillance system 10 is in a normal state, i.e., not in an emergency state, to save storage space.

As will be explained below, when the decision unit 16 determines that an object that is not registered with the database 164 as an approved user has entered, the decision unit 16 triggers an alarm unit 22 to generate an alarm. The alarm unit 22 can generate the alarm in a variety of ways, such as an audible alarm, a visual alarm, or by notifying the relevant authorities.

In this embodiment, two operation modes, normal mode and guarding mode, are implemented in the surveillance system 10. Initially, the surveillance system 10 starts in a normal mode, which stores video images on the storage unit 20 using a second image format. Meanwhile, the microphone arrays 14 are working to detect sound. When sound is detected, the decision unit 16 uses the signals provided by the microphone arrays 14 to estimate the location of the sound source. The decision unit 16 then instructs the driving unit 18 to point the video camera 12 at the estimated position. Since sound has already been detected, the surveillance system 10 switches from normal mode to guarding mode for attempting to detect if any intruder has caused the sound. In order to facilitate face recognition, the storage unit 20 stores video images with a first image format while in guarding mode. The first image format is different from the second image format in various ways. For example, as described in the previous paragraph, the image resolution and/or the color quality of the first image format applied in the guarding mode is higher than those of the second image format applied in the normal mode. The decision unit 16 then utilizes the face recognition and tracking unit 162 to track the face of the object that has entered the surveillance area in order to try and recognize the face. If the tracked face is not one that is registered in the database 164, this means that an intruder has entered, and the decision unit 16 triggers the alarm unit 22 to generate the alarm.

On the other hand, if the captured image is an approved user listed in the database 164, the surveillance system 10 will stop surveillance by stopping the camera recording and sound detection. The approved user may reactivate the surveillance system 10 when he or she leaves.

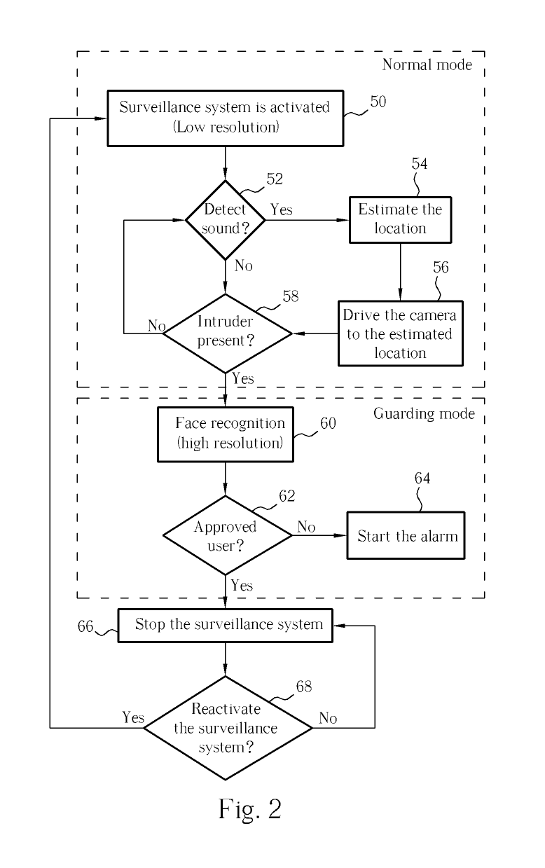

The operating method of the surveillance system 10 is summarized in the flowchart contained in FIG. 2. Steps contained in the flowchart will be explained below.

Step 50: The surveillance system 10 is activated in normal mode, and stores video in the storage unit 20 using low resolution or low color quality.

Step 52: Determine if the microphone arrays 14 have detected any sound. If so, go to step 54. If not, go to step 58.

Step 54: Estimate the location of the detected sound.

Step 56: The decision unit 16 instructs the driving unit 18 to point the video camera 12 at the estimated location.

Step 58: Determine if an intruder is present. The intruder can be detected through sounds picked up by the microphone arrays 14 or through images recorded by the video camera 12. If an intruder is present, go to step 60. If not, go back to step 52.

Step 60: The surveillance system 10 switches to guarding mode, and stores video in the storage unit 20 using high resolution or high color quality. The face recognition and tracking unit 162 performs face recognition using the increased video resolution.

Step 62: Compare the detected face with the facial images stored in the database 164 to determine if the intruder is an approved user. If the user is an approved user, go to step 66. Otherwise, go to step 64.

Step 64: The decision unit 16 triggers the alarm unit 22 to start the alarm.

Step 66: Stop the surveillance system 10 since an approved user has entered the surveillance area.

Step 68: Determine if the user has reactivated the surveillance system 10. If so, go back to step 50. Otherwise, go back to step 66.

In summary, a smart surveillance system is proposed that can actively track the location of the user using sound location estimation and face tracking. Moreover, the stored recording resolution can be actively changed depending on whether there is an intruder present or not. In addition, facial recognition can be used to automatically shut down the surveillance system if an approved user is present or to trigger the alarm if an unauthorized intruder is present.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A surveillance system, comprising:
a plurality of microphones for generating audio signals in response to detecting sound;
a video camera for generating a stream of video signals;
a driving unit for controlling the direction in which the video camera points; and
a decision unit for determining a location from which the detected sound is coming from based on the differences in the audio signals generated by the plurality of microphones to control the driving unit to point the video camera in the direction of the location from which the detected sound is coming from.

2. The system of claim 1, further comprising:
a database containing facial images corresponding to a list of approved users; and
a face recognition unit for comparing the face of an object filmed by the video camera with the facial images contained in the database, and for triggering an alarm when the object is not on the list of approved users.

3. The system of claim 1, further comprising a storage unit for storing the audio signals generated by the plurality of microphones and the stream of video signals generated by the video camera.

4. The system of claim 3, wherein the storage unit stores the stream of video signals with a first format when the decision unit indicates that an object is present based on the audio signals received from the plurality of microphones or the stream of video signals received from the video camera.

5. The system of claim 1, wherein the video camera generates video signals with a first image format when the decision unit indicates that an object is present based on the audio signals received from the plurality of microphones or/and the stream of video signals received from the video camera.

6. The system of claim 5, further comprising:
a database containing facial images corresponding to a list of approved users; and
a face recognition unit for identifying the face of the object detected by the video camera from the facial images contained in the database.

7. The system of claim 6, further comprising an alarm module, for generating alarm signals when the face recognition unit fails to identify the face of the object from the facial images contained in the database.

8. The system of claim 5, wherein the video camera generates video signals with a second image format when the decision unit indicates that no object is present based on the audio signals received from the plurality of microphones or/and the stream of video signals received from the video camera.

9. The system of claim 8, wherein image resolution of the first image format is higher than that of the second image format.

10. The system of claim 8, wherein color quality of the first image format is higher than that of the second image format.

11. A method of performing video and audio surveillance, the method comprising:
generating audio signals with a plurality of microphones;
generating a stream of video signals with a video camera;
determining a location from which the detected sound is coming from based on the differences in the audio signals generated by the plurality of microphones; and
driving the video camera to point in the direction of the location from which the detected sound is coming from.

12. The method of claim 11, further comprising:
providing a database containing facial images corresponding to a list of approved users;
filming the face of an object with the video camera;
comparing the face of the object with the facial images contained in the database; and
triggering an alarm when the object is not on the list of approved users.

13. The method of claim 12, further comprising stopping surveillance if the object is on the list of approved users.

14. The method of claim 11, further comprising storing the audio signals generated by the plurality of microphones and the stream of video signals generated by the video camera in a storage unit.

15. The method of claim 14, further comprising storing the stream of video signals with a first format when the decision unit indicates that an object is present based on the audio signals received from the plurality of microphones or the stream of video signals received from the video camera.

16. The method of claim 11, wherein the video camera generates video signals with a first image format when it is determined that an object is present based on the audio signals received from the plurality of microphones or/and the stream of video signals received from the video camera.

17. The method of claim 16, further comprising:
storing facial images corresponding to a list of approved users in a database; and
identifying the face of the object detected by the video camera from the facial images contained in the database.

18. The method of claim 17, further comprising generating alarm signals when failing to identify the face of the object from the facial images contained in the database.

19. The method of claim 16, wherein the video camera generates video signals with a second image format when it is determined that no object is present based on the audio signals received from the plurality of microphones or/and the stream of video signals received from the video camera.

20. The method of claim 19, wherein image resolution of the first image format is higher than that of the second image format.

21. The method of claim 19, wherein color quality of the first image format is higher than that of the second image format.
